(19) United States
(12) Patent Application Publication
(10) Pub. No.: US 2012/0011033 A1
(43) Pub. Date: Jan. 12, 2012

(54) SYSTEM FOR MANAGEMENT, MONITORING AND CONTROL OF HOTEL AMENITIES AND A METHOD THEREOF

(76) Inventor: Rahul Salgia, Indore (IN)

(21) Appl. No.: 13/187,444

(22) Filed: Jul. 20, 2011

Related U.S. Application Data
(63) Continuation of application No. PCT/IN2010/000033, filed on Jan. 19, 2010.

(30) Foreign Application Priority Data
Jan. 20, 2009 (IN) 127/MUM/2009

(51) Int. Cl. G06Q 10/00; G06Q 30/00

(52) U.S. Cl. 705/27.2; 705/1.1

(57) ABSTRACT

A system and a method for management, monitoring and control of hotel amenities for providing guests staying in discrete hotel rooms access to a plurality of hotel amenities through a single interface has been disclosed. The system 100 includes portable devices 102 which are provided to guests of a hotel and acts as a single point of access for controlling the use of all the amenities and a controller 112 which wirelessly interfaces with each of the portable devices 102 to facilitate the monitoring and control of the amenities.

### BACKGROUND OF INVENTION

### Field of the Invention

The present invention relates to the field of hospitality services.

Particularly, the invention relates to the field of guest communication in hospitality services.

Still particularly, the present invention relates to an interface for unifying all amenities in a hotel.

### DEFINITIONS OF TERMS USED IN THE SPECIFICATION

The expression ‘Amenities’ in this specification is used to refer to the services and facilities provided by the hotel for the convenience of their guests and in return to increase the guest satisfaction.

The expression ‘Enabling/Disabling’ in this specification is used to refer to activation and deactivation of the use of a certain amenity in a room based on the preference of the guest.

The expression ‘Hotel’ in this specification is used to refer to an accommodation, a lodging, a stay, a hotel or a resort whether in the form of a single building or a property spread across a particular area. The expression ‘hotel’ can be extended and applied to a residence, a guest house, a hostel, a boarding house, a bungalow, an apartment, a building, a housing society having two or more buildings and the like.

The expression ‘Guest’ in this specification is used to refer to any person staying temporarily or permanently, in the hotel defined above.

### BACKGROUND ART

Hospitality systems provide services which typically aim at making the stay of guests more comfortable and pleasing.

Typically, in today's scenario hospitality systems provide guests with many luxuries including air conditioning, television, phone, music and video players, automatic lighting systems, locking systems and the like. Services including food, housekeeping, emergency, travel desk and the like can also be availed by reaching out to the respective telephone extensions of these services. Keeping track of remote controls for plurality of electrical and electronic gadgets as well as the different service numbers creates discomfort for guests.

Also, providing a common/single interface for guests is again more convenient for guests as he/she can avail all the services through a single means. If this means is portable it is more comfortable and increases the pleasure of staying in the hotel.

Maintenance of these electronic and electrical gadget's is an overhead for the owners of hospitality services as replacing the batteries for the remote controls of these gadgets for each of the room and tracking the failures demands extra effort. Moreover, tracking any change to any of the services and facilities creates overhead for the management.

There is therefore felt a need to find a way to integrate these devices with existing in-room hotel systems to create better guest experience. A single, user friendly interface with which guests can avail all amenities implemented on a menu or icon driven touch screen system proves very handy for users. The guests should be able to request for services by just one touch on the device. This device can easily be updated if there are changes in the settings and management of each of the services and facilities.

### OBJECT OF THE INVENTION

It is an object of the present invention to provide a single, user friendly interface which can control and monitor all amenities including appliances, gadgets, entertainment services and the like in a room.

It is still another object of the present invention to provide a single platform for a user to operate and control electronic devices, electrical gadgets and the like.

It is still another object of the present invention to increase the guest experience.

It is still another object of the present invention to provide a single device which can display the information in a language requested by guests.

### SUMMARY OF INVENTION

The present invention envisages a system for management, monitoring and control of hotel amenities for providing guests staying in discrete hotel rooms access to a plurality of amenities through a single interface, the system comprising at least one controller and a plurality of portable devices,
portable devices resident in hotel rooms adapted to provide a single point of access for controlling the use of amenities, each of the portable devices having:
   display means adapted to discretely display various amenities available in a hotel;
   selector means adapted to be enabled by guests to select at least one displayed amenity;
   transmitting means adapted to transmit a request for the selected amenity;
the controller co-operating with the plurality of portable devices comprising:
   receiver means adapted to receive a transmitted request from the portable devices corresponding to the selected amenity;
   enabling and disabling means adapted to enable or disable use of the selected amenity based on the received request; and
   interfacing means co-operating with an existing hotel management server adapted to interface amenities provided by departments associated with the hotel management server with the portable devices; and
a communication interface to provide a communication channel between each of the portable devices and the controller.

Typically, each of the portable devices is a battery operated wireless touch screen device and comprises a repository for storing a plurality of audio/video files for viewing on electronic devices.

Preferably, each of the portable devices includes an RFID tag for facilitating tracking of its location.

Further, the each of the portable devices comprises a billing and payment interface and the controller comprises billing and payment means adapted to enable guests to make payment and receive acknowledgement for the payment on the portable device.

Still further, the amenities include the electronic and electrical devices, telephony, intelligent controls, temperature controls, drapery controls, lighting controls, door controls, door strike controls, do not disturb sign controls, housekeeping services, aroma controls, butler services, travel desk services, billing services, wake-up services, maintenance services, booking services, beauty services, restaurant services, laundry services, room services, gaming services, video on demand services, audio on demand services, souvenir shopping services, front desk services, book on demand services, conferencing services and VOIP services.

Furthermore, the system comprises a plurality of RFID tags which are attached to a plurality of electronic devices and non-complimentary consumables provided in hotel rooms to facilitate billing.

In addition, the display means is adapted to display the amenities using a user interface selected from the group consisting of an icon based user interface and a menu based user interface.

Additionally, the selector means comprises touch screens, keypads and audio receivers.

Typically, the controller includes a Wi-Fi Access Point adapted to facilitate communication and data synchronization between the controller and the hotel room amenities, the Wi-Fi Access Point further adapted to provide wireless Internet access in hotel rooms.

Preferably, the controller further comprises:
optimization means to automatically control operations of the amenities to increase guest experience and save energy; and
alarming means to provide audio and visual alarms/alerts to the amenities provided in each room and to the hotel management in the event of an emergency.

In accordance with this invention, the communication interface is a real-time two-way communication based wireless interface adapted to carry encrypted communication signals on the communication channel for enhanced security.

Preferably, the system comprises a plurality of controlling means co-operating with the amenities within a hotel room, each of the controlling means connected to the controller using an RS232 interface.

In accordance with this invention there is provided a method for management, monitoring and control of hostel amenities for providing guest staying in discrete hotel rooms access to a plurality of hotel amenities through a single interface, the method comprising the following steps:
displaying a plurality of the hotel amenities available in a hotel on a portable device's user interface;
selecting a displayed amenity and the desired operation;
transmitting the signal consisting of the selected amenity and the desired operation;
receiving the transmitted signal at a remote controller; and
controlling the operation of the selected amenity based on the received signal for the benefit of the guest.

Typically, the step of displaying the various amenities includes the step of displaying the amenities via an icon based or menu based interface and in a language of the guest's choice.

Preferably, the step of controlling operation of the selected amenity includes the step of providing a plurality of controlling means for controlling operation of the amenities and sending control signals to the controlling means for facilitating operation of the selected amenity based on the received signal.

### BRIEF DESCRIPTION OF DRAWINGS

The hospitality system in accordance with the present invention can be described with the help of accompanying drawings, in which:

FIG. 1 illustrates a schematic of the system for providing a single interface for controlling the use of amenities provided in a hotel room, in accordance with the present invention;

FIG. 2 is a block diagram showing the interconnection of the system in accordance with the present invention; and

FIG. 3 illustrates a flow chart showing the steps for providing a single interface for controlling the use of amenities provided in a hotel room, in accordance with the present invention.

### DETAILED DESCRIPTION

The present invention envisages a system for providing a single interface for accessing a plurality of hotel amenities provided to guests staying in discrete hotel rooms.

Particularly, the system in accordance with this invention is a user friendly interface which can be availed typically through a menu or icon driven touch screen wireless or wired communication device which can either be embedded in or mounted on a wall or can be portable. In accordance with the preferred embodiment of the present invention, guests can use this device for controlling the use of the amenities in a hotel room.

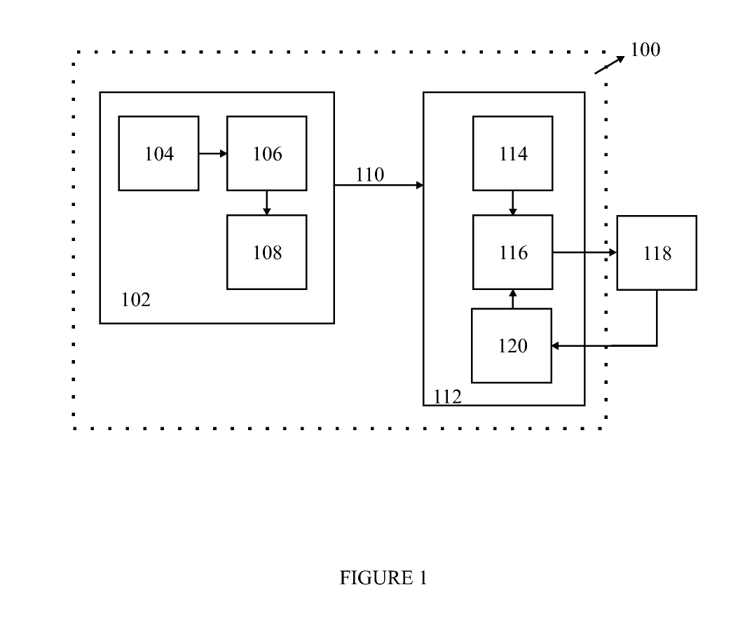

Referring to the accompanying drawings, FIG. 1 gives a high level view of the system 100 for management, monitoring and control of hotel amenities through a single interface.

The system as represented by reference numeral 100 comprises at least one controller 112 and a plurality of portable devices 102 provided to guests staying in discrete hotel rooms and a communication interface 110 to provide a communication channel between the portable devices 102 and the controller 112.

The portable devices 102 are resident in the hotel rooms and provide a single point of access for controlling the use of hotel amenities. In accordance with one aspect of the present invention, the portable devices 102 are typically, either a menu or an icon driven touch screen devices with cascading screens for multiple options for controlling the use of amenities.

The each of the portable devices 102 consist of:
display means 104 to discretely display various amenities represented by reference numeral 118 available in the hotel;
selector means 106 which is enabled by guests to select a displayed amenity. The selector means includes touch screens, keypads and audio receivers based input; and
transmitting means 108 to wirelessly transmit a request for the selected amenity.

In accordance with another aspect of the present invention, the portable device 102 comprises a repository (not shown in the figures) for storing a plurality of audio/video files for hearing/viewing on the electronic devices like television and DVD player present in the room. Thus, guests can select a wide range of audio and video files locally from the portable device 102 itself.

The controller 112 can be located within the room, outside the room or partially inside the room and consists of:
receiver means 114 to receive the transmitted request corresponding to the selected amenity from the portable devices 102;
enabling and disabling means 116 to enable or disable use of the selected amenity for the benefit of guests; and
interfacing means (not shown in the figures) to interface units associated with an existing hotel management server with the portable devices 102 to facilitate access and receive information from these units on the portable devices 102.

The communication interface 110 is a two-way communication based wireless interface, typically a Wi-Fi communication channel. Being a two-way communication channel it enables the controller 112 and the portable devices 102 to communication with each other. Additionally, the communication between the controller 112 and the portable devices 102 is encrypted by the communication interface 110 before sending to either of the devices i.e. controller or the portable device for enhanced security over the wireless communication interface 110. Thus, due to encryption of the communication no hacker can either hack the Wi-Fi network or send commands to the controller 112 to enable or disable the security of hotel rooms or hotel at large.

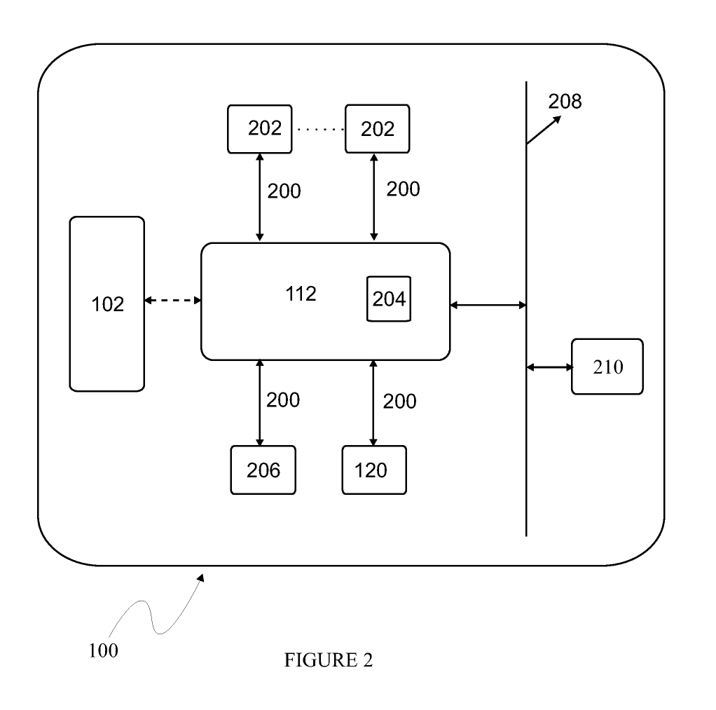

FIG. 2 illustrates a block diagram of the controller 112 and its various interfaces.

The controller 112 wirelessly connects to the portable device 102 using the Wi-Fi technology. The controller 112 includes a Wi-Fi Access Point 204 which facilitates the communication and data synchronization between the portable devices 102, the controller 112 and the hotel amenities 210. In addition, the Wi-Fi access point 204 provides wireless Internet access in the hotel room.

The controller 112 co-operates with a plurality of discrete controlling means 202 which act like an interface between the controller 112 and electrical and electronic amenities present in hotel rooms. For instance, lightening controlling means 202 is used for controlling the brightness and the color of hotel room lighting as per the need of the guests. Similarly, there are separate controlling means for drapes, electronic gadgets, door controls and the like. The controller 112 interfaces with these controlling means 202 using an RS 232 interface 200. Typically, the different amenities controlled by the controller 112 through the RS232 serial port communication are GSM FCT router, television, music-DVD-Radio-Music Files, IR emitter, lighting controller, drapes, door strike and the like.

The controller 112 comprises an optimization means 120 to efficiently control the operations of amenities, for instance if a hotel guest wants to view a movie using the video on demand service, the controller 112 facilitates the playing of the selected movie on the television and further the optimization means 120 enhances the guest experience by changing the hotel room lighting suitable to the ambience, draws the drapes/curtains and automatically turns the do not disturb sign ON. In addition, the optimization means 120 aids in saving energy, for instance if the guest is not using the bathroom however the bathroom light is ON, the optimization means 120 after a pre-determined time detects the activity in the room and automatically turns the bathroom light OFF thus saving energy.

In addition, the controller 112 comprises of billing and payment means 206 which tracks all transactions performed by guests including the transactions performed outside the hotel room or purchase of souvenirs. For instance, if the guest accesses a restaurant area and requests to add the bill to his account, an interim bill is generated and added to the final billing of the guest by the billing and payment means 206. Also, during checkout if the guest requests for the final billing via the portable device 102, he/she makes the payment using the interface provided by the billing and the payment means 206 and receive the acknowledgement for the payment from the portable device 102 itself. As soon as the payment is accepted the refrigerator gets automatically locked and notification is sent to housekeeping and front desk services. Typically, housekeeping will be notified to collect the luggage and check the amenities in the room and usage of products kept in the refrigerator. On notification from housekeeping, front desk will keep the hardcopy of the bills ready. In case of any disputes the front office will make necessary adjustments.

Also, the consumables and the in-room utilities like the hair dryers, iron, electric kettle, electric shavers and the non-complimentary items are tagged with RFID (Radio Frequency Identification) tags to enable the tracing of these non-complimentary items. The controller 112 keeps a track of these items and in case they are not detected within the room the price of the item is notified to the payment and billing means 206 and added to the final bill of the guest and in addition the Front Desk of the hotel is also informed of the same.

Additionally, the portable devices 102 also have an RFID tag to ensure that the portable devices are not misplaced or taken outside the room. The RFID tag of the portable device 102 is tracked by the controller 112 and in event of its loss the controller 112 can trace its location.

Further, the system 100 includes alarming means (not shown in the Figures) which generates alerts/alarms for the controllers 112 to indicate a warning or a security threat. The alarms are audio and visual based. Typically, in alarm or alert cases the camera either in built in the portable device 102 or an IP camera/webcam accessible by local area network can be turned on to check the safety of guests and to provide aid and help in evacuation in case of emergency. The cameras help the hotel management to get a view/room plan of each of the rooms and exactly spot the area where the threat is found, for instance in case of fire the hotel management will know that the fire has started in room no X near the window.

Additionally, the controller 112 connects through local area network 208 to the various non-electronic and non-electrical amenities 210 preferably utilizing WiFi technology. These amenities 210 include the IP camera, Internet connectivity, Anti-theft and Maintenance Services, Video on Demand service, Hospitality Management Integration services and the like.

In accordance with the yet another aspect of the present invention, the menus or icons on the portable devices 102 preferably include but are not limited to options for choosing controls, services, facilities and utilities based amenities.

In accordance with this present invention, the portable device 102 can provide access to at least the following control amenities:
Control for television: This includes controls for channel surfing, volume, contrasts, brightness, channel tuning and the like. Typically, channel tuning can be performed by at least name or iconic logo.
Control for DVD players: This includes controls for play, forward, rewind, pause, eject and the like
Control for music systems: This includes controls for play, forward, rewind, pause, eject, volume, CD changer and the like.
Intelligent Controls: In accordance with the present invention, the portable device can be used for changing the mode of operation of the television to adapt to the right source. Typically, the device will automatically change the mode of operation of television to AV when video on demand is selected.
Control for added sound experience: Effects including stereo, theater, sound absorption and the like.
Control for air conditioning: This includes turning on and off the air conditioner, temperature and humidity controls and the like.
Control for lighting systems: This includes automatic turning on and off of lights based on the time, adjustment of brightness and color of light as per the users emotions, automatic turning on and off of power supply as the user enters or leaves the room and the like.
Control for drapes and curtains: This includes automatic drawing and opening of curtains, rolling of curtains and drapes and the like
Control for locks: This includes automatic locking of front door, locker, wardrobe, refrigerator and the like as the user leaves the room. Automatic unlocking of front door can be achieved by the portable device 102. In accordance with the preferred embodiment of the present invention, automatic unlocking provision is given for allowing entry to a visitor after viewing his/her video on the portable device 102.
Control for aroma: In accordance with the present invention, the portable device 102 can connect to aroma emitting devices and enable the users to choose the type and intensity of the fragrance according to his preference. Also provision can be given to mix multiple fragrances in user's preferred compositions.
Control for massaging equipment: In accordance with the present invention, the portable device 102 can control the massaging mode, intensity, vibration, recline of the equipment and the like.
Control of bed movements: In accordance with the present invention, reclining of the bed can be controlled through this interface.
SMS Controls: In accordance with the preferred embodiment of the present invention, users can control electronic gadgets by typically using the messaging system. Specifically users can send an SMS to the controller of the system to put on the air conditioner via the Wi-Fi interface. Similarly the controller can accept commands on SMS and act accordingly. On the other hand the system can send the status of some of the electronic devices through SMS.
Internet Controls: Internet can be surfed using the portable device 102. The touch screen becomes the track pad and keyboard for the user when there is a need to surf the Internet. The hotel room TV becomes the display and the browser window opens up there.

Service Amenities:

In accordance with the present invention, the portable device 102 can provide control and access to at least the below Services amenities:
Housekeeping including laundry services, shoe shine, making up the room, request for toiletries, request for newspaper, magazines and the like.
Emergency services including medical assistance, medicines, first aid, electronic failures, security services and the like. Typically, in case of emergency evacuation a message can be displayed on the television and an alarm can also be played on the television so that the hotel admin does not have to call every guest in the room. Further if the television is in switched off or stand by mode it can be put on and the message will be displayed.
Front Desk services including call forwarding, missed call alerts, provision for voicemail, wake-up calls, visitor notifications, reservations, billing and the like.
Restaurant services including order placements, table booking for the restaurants, cultural event notifications and the like
Travel desk services including ticket bookings, call for taxi and transport, guide provision and the like.

Facilities Based Amenities:

In accordance with the present invention, the interface can provide control and access to at least the below facilities based amenities:
Library: In accordance with the present invention, guests can browse the interface provided by the portable device 102 to view the list of books available in the library and call for the same. They can also check the status of the book and incase they are not available they can reserve the books.
Video and audio on demand: In accordance with the present invention, guests can browse the available DVDs, CDs, MP3s and the like and the selection will be played on the guest's television. Play lists of the selected audio and video songs can also be compiled and played on the guest's television. Moreover, guests can also search for a particular song by searching using keywords including actors name, director's name, songs title, movie title and the like. Details of the selected song including movie title, names of actors, director, composer and the like can also be viewed. Guests can pause, rewind and forward the on demand files as per their wish.
Live meeting, VoIP and video conferencing: In accordance with the present invention, guests can connect to business meetings from the comfort of their room through video conferencing and the like.
Making phone calls: The portable device will enable guests to make local, national and international calls.
Beauty and fitness facilities: In accordance with the present invention, guests can take appointments for beauty treatments and information about the fitness facilities and their timings can be browsed through the portable device 102 interface.

Utilities Based Amenities:

In accordance with the present invention, the portable device 102 can provide at least the below Utilities based Amenities:
Alarm systems: This includes wake-up as well as travel notifications
Forex updates: This includes updated FX conversion information for all major currencies.
Currency and metric converters: This includes provision for currency and metric conversions.
Calculators
Language translators: This provision can be provided for guests to browse the information on the interface in the language of their choice.
Ticker news updates
Stock market updates
Non occupied room monitoring: In case of non-occupied rooms, the camera inbuilt in the portable device or IP camera/Webcam can be turned on for checking unauthorized occupancy.

In addition to the above aspects, the controller 112 tracks all the transaction done through the portable device 102 interface. Paid transactions are saved to the billing account of the guest. At the time of checkout or final settlement all the bills are added with the necessary taxes and a final bill is generated by this server.

This controller 112 acts as a central control for the hotel and prioritizes the service requests for use of hotel amenities received from multiple rooms. In accordance with the present invention, if two amenity requests, one for medical assistance and other for food ordering are placed, the controller 112 will give high priority to medical assistance. Alternatively, the priority is implemented according to class of the hotel rooms for instance if it's a deluxe room, executive room or a suite.

In accordance with the present invention, the controller 112 integrates the portable device 102 with an existing hotel management server which is the server which integrates the portable devices 102 in hotel rooms with the other units associated with the hotel management server like restaurant, front desk, travel desk, spa and the like via interfacing means (not shown in the figures). Thus, the controller 112 furnishes status messages regarding service requests to portable devices 102 via interfacing means (not shown in the figures). For instance, if a guest has placed an order for food, then he will be advised of the delivery timing and status thus creating greater guest experience. Moreover, the interfacing means enables hotel staff to publish announcements regarding events and general guidelines on portable device 102 interfaces which can be retrieved by guests at their convenience.

In addition, the controller 112 due to its interface with the hotel management server can receive the details of the missed calls received for guests, messages from visitors, voicemail alerts and the like from the front office in the form of a text message and further send it to the portable device 102 of that guest. These messages can be retrieved as per the guest's convenience.

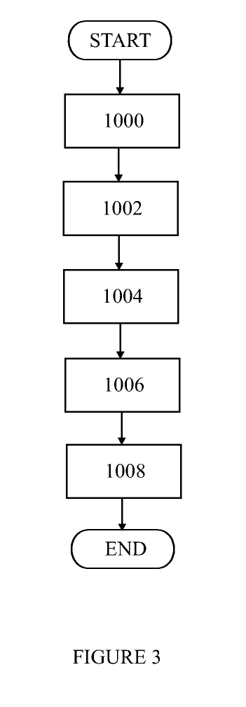

In accordance with the present invention there is provided a method for management, monitoring and control of hotel amenities for providing guest staying in discrete hotel rooms' access to a plurality of hotel amenities through a single interface, the method comprising the following steps as seen in FIG. 3:
displaying a plurality of the hotel amenities available in a hotel on a portable device's user interface 1000;
selecting a displayed amenity and the desired operation 1002;
transmitting the signal consisting of the selected amenity and the desired operation 1004;
receiving the transmitted signal at a remote controller 1006; and
controlling the operation of the selected amenity based on the received signal for the benefit of the guest 1008.

Typically, the step of displaying the various amenities includes the step of displaying the amenities via an icon based or menu based interface and in a language of the guest's choice.

Preferably, the step of controlling operation of the selected amenity includes the step of providing a plurality of controlling means for controlling operation of the amenities and sending control signals to the controlling means for facilitating operation of the selected amenity based on the received signal.

### TECHNICAL ADVANCEMENTS

The technical advancements for the present invention include:
providing a single, user friendly portable device which can control the use of a plurality of amenities in a hotel room;
providing a single portable device typically icon or menu driven touch screen interface for controlling the use of the plurality of amenities in a hotel room;
providing a single platform for guests to operate and control electronic devices, electrical gadgets and the like. In accordance with the preferred embodiment of the present invention, the wireless touch screen device will be a single interface for controlling television, DVD players, audio systems, air conditioning and the like in a room;
increasing guest experience by changing the aroma, light settings relative to brightness and color, as per the guest's disposition. In accordance with the preferred embodiment of the present invention, the guest can change the color of the lighting system as per his liking; the brightness of the lights can automatically change depending on the moods of the guest;
providing a single device for accessing all services typically related to hospitality industry including all housekeeping services (request for making the bed, towels, toiletries, shoe shine and the like), emergency services (medical aids, gadget failures, security failures and the like), front desk services (reservations, call facilities, billing and the like), library, video and audio services, beauty and fitness services and the like;
providing a single device for accessing all facilities typically related to hospitality industry including food ordering facility, travel desk, table reservations and the like;
providing a single device for communication typically between the hospitality system and guests (missed call alerts, voicemails, announcements, notifications) and also among guests of the system. In accordance with the preferred embodiment of the present invention, the guest will receive notifications of the status of their service requests on this device;
providing a single device for connecting to the internet services including video conferencing, net meeting, VoIP and the like;
providing a single device for controlling drapes, curtains, bed movements and the like typically related to hospitality industry;
providing a single device which can display the information in a language preferred by the guest;
storing the transaction history for all the room interfaces;
providing a single device for facilitating utilities like wake-up alarms, calculators, currency and metric converters, forex updates, travel alarms, lockers, centralized locking, automatic turning on and off of power supply and the like;
in accordance with the preferred embodiment of the present invention, the overhead of printing and maintaining menus, hotel information, phone extensions, general guidelines and the like can be eliminated by uploading the information on the portable device;
the language translation provided by the portable device can aid the non-English speaking guests;
monitoring of unauthorized occupancy and provision of alerting guests in case of threats can be achieved;
in case of emergency evacuation a message can be displayed on the television and an alarm can also be played on the television so that the hotel admin does not have to call every guest in the room. Further if the television is in switched off or stand by mode it can be put on and the message will be displayed; and
video of visitors can be seen on the touch screen device and if the guest wishes to allow entry the door of the room will automatically be unlocked.

While considerable emphasis has been placed herein on the components and component parts of the preferred embodiments, it will be appreciated that many embodiments can be made and that many changes can be made in the preferred embodiments without departing from the principles of the invention. These and other changes in the preferred embodiment as well as other embodiments of the invention will be apparent to those skilled in the art from the disclosure herein, whereby it is to be distinctly understood that the foregoing descriptive matter is to be interpreted merely as illustrative of the invention and not as a limitation.

What is claimed is:

1. A system for management, monitoring and control of hotel amenities for providing guests staying in discrete hotel rooms access to a plurality of amenities through a single interface, said system comprising at least one controller and a plurality of portable devices,
portable devices resident in hotel rooms adapted to provide a single point of access for controlling the use of amenities, each of said portable devices having:
display means adapted to discretely display various amenities available in a hotel;
selector means adapted to be enabled by guests to select at least one displayed amenity; and
transmitting means adapted to transmit a request for the selected amenity;
the controller co-operating with said plurality of portable devices comprising:
receiver means adapted to receive a transmitted request from said portable devices corresponding to said selected amenity;
enabling and disabling means adapted to enable or disable use of said selected amenity based on the received request; and
interfacing means co-operating with an existing hotel management server adapted to interface amenities provided by units associated with the hotel management server with said portable devices; and
a communication interface to provide a communication channel between each of said portable devices and said controller.

2. The system as claimed in claim 1, wherein each of said portable devices is a battery operated wireless touch screen device and comprises a repository for storing a plurality of audio/video files for viewing on electronic devices.

3. The system as claimed in claim 1, wherein each of said portable devices includes an RFID tag for facilitating tracking of its location.

4. The system as claimed in claim 1, wherein said each of said portable devices comprises a billing and payment interface and said controller comprises billing and payment means adapted to enable guests to make payment and receive acknowledgement for the payment on said portable device.

5. The system as claimed in claim 1, wherein said amenities include the electronic and electrical devices, telephony, intelligent controls, temperature controls, drapery controls, lighting controls, door controls, door strike controls, do not disturb sign controls, housekeeping services, aroma controls, butler services, travel desk services, billing services, wake-up services, maintenance services, booking services, beauty services, restaurant services, laundry services, room services, gaming services, video on demand services, audio on demand services, souvenir shopping services, front desk services, book on demand services, conferencing services and VOIP services.

6. The system as claimed in claim 1, wherein said system comprises a plurality of RFID tags which are attached to a plurality of electronic devices and non-complimentary consumables provided in hotel rooms to facilitate billing.

7. The system as claimed in claim 1, wherein said display means is adapted to display said amenities using an user interface selected from the group consisting of an icon based user interface and a menu based user interface.

8. The system as claimed in claim 1, wherein said selector means comprises touch screens, keypads and audio receivers.

9. The system as claimed in claim 1, wherein said controller includes a Wi-Fi Access Point adapted to facilitate communication and data synchronization between said controller and said hotel room amenities, said Wi-Fi Access Point further adapted to provide wireless Internet access in hotel rooms.

10. The system as claimed in claim 1, wherein said controller further comprises:
optimization means to automatically control operations of said amenities to increase guest experience and save energy; and
alarming means to provide audio and visual alarms/alerts to said amenities provided in each room and to the hotel management in the event of an emergency.

11. The system as claimed in claim 1, wherein said communication interface is a real-time two-way communication based wireless interface adapted to carry encrypted communication signals on said communication channel for enhanced security.

12. The system as claimed in claim 1, wherein said system comprises a plurality of controlling means co-operating with said amenities within a hotel room, each of said controlling means connected to said controller using an RS232 interface.

13. A method for management, monitoring and control of hostel amenities for providing guest staying in discrete hotel rooms access to a plurality of hotel amenities through a single interface, said method comprising the following steps:
displaying a plurality of said hotel amenities available in a hotel on a portable device's user interface;
selecting a displayed amenity and the desired operation;
transmitting the signal consisting of the selected amenity and the desired operation;
receiving the transmitted signal at a remote controller; and
controlling the operation of the selected amenity based on the received signal for the benefit of the guest.

14. The method as claimed in claim 13, wherein the step of displaying the various amenities includes the step of displaying the amenities via an icon based or menu based interface and in a language of the guests choice.

15. The method as claimed in claim 13, wherein the step of controlling operation of the selected amenity includes the step of providing a plurality of controlling means for controlling operation of said amenities and sending control signals to said controlling means for facilitating operation of said selected amenity based on the received signal.
